(19) United States
(12) Patent Application Publication
(10) Pub. No.: US 2003/0194539 A1
(43) Pub. Date: Oct. 16, 2003

(54) Ink-jet recording medium and ink-jet image forming method using the recording medium

(76) Inventors: Hidenobu Ohya, Tokyo (JP); Shuji Kida, Tokyo (JP); Shinichi Suzuki, Tokyo (JP); Makoto Kaga, Tokyo (JP); Teruyuki Fukuda, Tokyo (JP)

Correspondence Address: Cameron Kerrigan, Squire, Sanders & Dempsey L.L.P., Suite 300, One Maritime Plaza, San Francisco, CA, 94111, US

(21) Appl. No.: 10/208,079

(22) Filed: Jul. 29, 2002

(30) Foreign Application Priority Data
Aug. 8, 2001 (JP) 2001-240511

(51) Int. Cl. B32B 3/00

(52) U.S. Cl. 428/195

(57) ABSTRACT

The invention relates to an ink jet recording material comprising a support having thereon an ink absorbing layer, the ink jet recording material having an outer layer containing a thermoplastic resin, wherein the ink jet recording material has an ink transfer amount of not less than 10 ml/m² for a contacting time of 40 milliseconds according to Bristow method, and an ink jet image recording method utilizing said ink jet recording material.

### FIELD OF THE INVENTION

The invention relates to an ink-jet recording medium, hereinafter referred to as a recording medium, and an ink-jet image forming method using the recording medium.

### BACKGROUND OF THE INVENTION

Recently, the technology of the ink-jet recording has been considerably progressed, and an image having a high quality, so called as photographic image quality, can be obtained by progress of technology of printer, ink and recording medium to be exclusively used for the ink-jet recording. Accompanied with the rising of the image quality, the storage ability of the image formed by the ink-jet is become to be compared with that of the usual silver halide photography, and the degradation of the image caused by the moving of the colorant such as low water-proof ability and the low anti-spreading ability and the degradation a chemical reaction such as the low light-fastness and the low resistively against an oxidant gas are pointed out.

Many means have been proposed for improvement of the storage ability. For instance, Japanese Patent Examined Publication No. 2-31673 discloses that the improvement of the water-proof ability and the weather resistance and the raising of the image glossiness of the ink-jet recording medium can be attained by providing a layer constituted by a thermoplastic organic polymer particle at the outermost surface of the medium and forming a polymer protective layer after the image formation by fusing the thermoplastic organic polymer particle.

On the other hand, however, the ink-absorbing speed is made considerably lower than that of a porous recording medium principally constituted by an inorganic pigment, when the layer of the thermoplastic organic polymer particle is provided on the surface of the recording medium. The lowering of the ink-absorbing speed causes degrading of the image quality by occurrence of color bleeding and beading. Particularly, such the image degradation causes a large problem accompanied with rising of the printing speed corresponding to a recent demand of high speed printing.

Any effective countermeasure to such the problem cannot be found yet even though various investigations have been carried out for increasing the ink-absorbing speed when the surface layer constituted by the thermoplastic organic polymer particle is provided. For example, a means by making large the diameter of the thermoplastic organic polymer particle is proposed in Japanese Patent Publication Open to Public Inspection, hereinafter referred to as JP O.P.I. Publication, No. 2000-203151. However, such the means is not suitable for the high-speed image formation since a long time is necessary to form a layer by fusing of the thermoplastic organic polymer particle when the particle diameter is made larger.

JP O.P.I. Publication No. 7-237248 discloses a method by which a silica particle is added to the outermost surface layer constituted by the thermoplastic organic polymer particle. However, the ink-absorbing speed is rather than lowered in such the embodiment since a part of the pores constituted by the thermoplastic organic polymer particle is filled up by the silica particle. The improving effect of the silica particle is insufficient since the effect of the silica is remained within the range of an additive even if the diameter distribution of the silica particle is controlled. JP O.P.I. Publication No. 2000-280603 discloses a method by which colloidal silica is added in an amount of not more than 30% into the thermoplastic organic polymer particle of the outermost layer for raising the chroma of image but no improving effect on the ink-absorbing speed is observed.

The following problems have been newly found additionally to the image quality degrading by the color bleed and the beading by the inventors as a result of the investigation on the high-speed image formation using the recording medium having the outermost layer constituted by the thermoplastic organic polymer particle.

The first problem is that the image surface tends to be contaminated when the fixation by heating is applied just after the printing of the image. Such the phenomenon causes an image defect in the course of continuous printing. It has been confirmed that the contamination is not caused by the unabsorbed ink since the surface of the recording medium is dried.

The second problem is that glossiness of the surface becomes insufficient when the fixation by heating is applied just after the printing the image. Particularly, in the case of using a pigment ink, the image quality is considerably degraded when the addition of glossiness is insufficient.

The third problem is that cracks are easily formed in the course of the production of the recording medium. Such the problem is frequently occurred when a thick ink-absorbing layer is formed to obtain the layer having high ink absorbability for responding to a printer using a combination of a high color density and a low color density inks.

The fourth problem is the water-proof ability of the image after the fixing treatment, particularly increasing of peeling of the layer caused by water such as rain water.

As above-mentioned, some degree of rising of the storage ability image and the adding of glossiness to the image can be expected to the thermal treatment of the ink-jet medium having a layer constituted by the thermoplastic organic polymer particle. However, the falling of the image quality such as the occurrence of the color bleeding and the beading, and the problems such as occurrence of the contamination of the fixing device when the fixing by heat is applied just after the printing for rapid image formation, the insufficient provision of glossiness and the lowering of the water-proof ability are occurred. Moreover, the problem that the cracks are easily formed in the course of the production is raised. Thus it is demanded to rapidly solve such the many problems on the recording medium.

### SUMMARY OF THE INVENTION

The first object of the invention is to provide an ink-jet recording medium and an ink-jet image forming method using the recording medium by which a high-quality image can be formed without occurrence of the color bleeding. The second object of the invention is to provide an ink-jet recording medium and an ink-jet image forming method using the recording medium by which the contamination of the fixing device is not occurred even when the fixing treatment is applied just after the printing. The third object of the invention is to provide an ink-jet recording medium and an ink-jet image forming method using the recording medium by which an image having high glossiness and high water-proof ability can be obtained. The fourth object of the invention is to provide an ink-jet recording medium and an ink-jet image forming method using the recording medium, in the production course of which the scratches are difficultly occurred.

The above objects of the invention can be attained by the following constitution.

1. An ink jet recording material comprising a support having thereon an ink absorbing layer, the ink jet recording material having an outer layer containing a thermoplastic resin,

wherein the ink transfer amount of the ink jet recording material is not less than 10 ml/m² for a contacting time of 40 milliseconds according to Bristow method.

2. The ink jet recording material described in the above Item 1, wherein the ink transfer amount for a contacting time of 40 milliseconds of the ink jet recording material is not more than 30 ml/m².

3. The ink jet recording material described in the above Item 1, wherein the outer layer further comprises inorganic pigments.

4. The ink jet recording material described in the above Item 3, wherein the weight ratio of the thermoplastic resin to the inorganic pigments in the outer layer is from 9:1 to 1:9.

5. The ink jet recording material described in the above Item 4, wherein the weight ratio of the thermoplastic resin to the inorganic pigments in the outer layer is from 6:4 to 4:6.

6. The ink jet recording material described in the above Item 1, wherein the ink absorbing layer comprises a water-soluble binder, and in the course of production of the ink jet recording material, a hardener for the water-soluble binder is supplied to the ink jet recording material after forming the ink absorbing layer.

7. The ink jet recording material described in the above Item 1, wherein the ink jet recording material is stored at a temperature within the range of from 35 to 70° C. for not less than 24 hours and not more than 60 days in the course of production of the ink jet recording material after layer-coating and drying.

8. The ink jet recording material described in the above Item 1, wherein the ink jet recording material has an ink transfer amount of not less than 20 ml/m² for a contacting time of 200 milliseconds according to Bristow method.

9. The ink jet recording material described in the above Item 1, wherein the ink jet recording material has a water-absorbing amount of from 22 ml/m² to 60 ml/m².

10. The ink jet recording material described in the above Item 1, wherein the solid component amount of the thermoplastic resin in the outer layer is form 2 g/m² to 20 g/m².

11. An ink jet image forming method comprising:

jetting an ink on to the ink jet recording material described in claim 1, and

fusing the thermoplastic resin in the outer layer or forming a film of the thermoplastic resin in the outer layer.

12. The ink jet image forming method described in the above Item 11, wherein the fusing step or the film-forming step is carried out by at least one of heating, pressing and coating a solvent.

13. The ink jet image forming method described in the above Item 11, wherein the ink is a pigment ink.

The causes of the degradation of the image quality, the contamination of the fixing device, the degradation of the glossiness and the water-proof ability and the occurrence of the cracks in the ink-jet recording medium in the course of the production have been analyzed by the inventors. As a result of the analyzing, it has been found that the problems can be solved by setting the transfer amount of the ink at a specified time to a specific condition according to Bristow method. Moreover, it has been found that the transfer amount of the ink can be set to the specific condition by 1) using an inorganic particle together with the thermoplastic resin, 2) supplying a water-soluble binder hardening agent in the course of the production of the recording medium and 3) applying a heat treatment for a certain period at a specified temperature after the production of the recording medium. The objects of the invention can be attained by applying each of the foregoing methods or suitable combination thereof.

### BRIEF DESCRIPTION OF THE DRAWINGS

FIG. 1 shows a schematic constitution of an ink-jet recording apparatus having a heating roller usable in the invention.

FIG. 2 shows a schematic constitution of an ink-jet recording apparatus having a heating belt usable in the invention.

### DETAILED DESCRIPTION OF THE INVENTION

The invention is described in detail below.

In the invention, the transfer amount of the ink to the ink-jet recording medium is not less than 10 ml/m². The transfer amount of the ink is preferably from 10 ml/m² to 30 ml/m².

In the invention, Bristow method is a method for measuring the liquid absorbing behavior of paper or cardboard in a short period. The measurement is performed according to the test method of liquid absorbing property of paper or cardboard defined by J. TAPPI Paper and Pulp Test Method No. 51-87 (Bristow method), and the measurement result is represented by the transfer amount of ink ml/m² for a contact time of 40 milliseconds. In the invention, the measurement is carried out using the later-described aqueous ink for easily judging the measuring area even though the measurement is carried out using purified water or ion-exchanged water in the above-mentioned measuring method.

The concrete measuring method of the ink transfer amount in the invention is described below.

The transfer amount of ink is measured by, for example, a pressure applying type Bristow Testing Machine II, manufactured by Kumagaya Riken Kogyo Co., Ltd., as a dynamic liquid absorption testing machine. As the liquid to be used for measurement, an aqueous magenta ink is used which is constituted by a magenta azo dye, 8% of ethylene glycol, 9% of glycerol, 9% of triethylene glycol monobutyl ether and a surfactant and has a viscosity of 3.4 cp at 25° C., a surface tension of 33 ml/m at 25° C. and a light absorbency of 1000. The transfer amount of the ink can be determined by measuring the magenta dyed area on the recording medium after the defined contacting time.

The invention is characterized in that the transfer amount of the ink for the contact time of 40 milliseconds is not less than 10 ml/m². The transfer amount of the ink is preferably from 10 ml/m² to 30 ml/m², more preferably from 14 ml/m² to 30 ml/m², further preferably from 14 ml/m² to 20 ml/m².

Furthermore, in the invention, the transfer amount of the ink for the contact time of 200 milliseconds is preferably from 20 ml/m² to 40 ml/m², more preferably from 24 ml/m² to 40 ml/m², particularly preferable from 24 ml/m² to 30 ml/m².

In the invention, the water-absorbing amount of the recording medium is preferably from 22 ml/m² to 60 ml/m², more preferably from 25 ml/m² to 60 ml/m², particularly preferably from 25 ml/m² to 35 ml/m².

The water-absorbing amount in the invention is measured by the following method.

A certain area of the recording medium is conditioned for 24 hours or more in an atmosphere of 25° C. and a relative humidity of 50%, and then immersed in purified water for 10 seconds. At this time, the recording medium is suitably vibrated to remove bubbles formed on the surface of the recording medium since the bubbles adhered on the surface of the recording medium inhibit the absorption of water. The bubbles are formed by air contained in the pores of the surface of the recording medium accompanied with the permeation of water. The recording medium is raised from the water after 10 seconds and water adhered onto the surface of the recording medium is quickly removed by a water-absorbing material such as filter paper and weighed. The amount of absorbed water can be determined by the difference of the weight before the immersion and that after the immersion.

The ink-jet recording medium according to the invention is described below.

It is one of the characteristics of the invention that the ink-jet recording medium constituted by an ink-absorbing layer provided on the support has the outer layer containing the thermoplastic resin.

The ink-absorbing layer is roughly classified into a swelling type and a porous type.

In the swelling type, the ink-absorbing layer is formed by coating a water-soluble binder such as gelatin, poly(vinyl alcohol), polyvinylpyrrolidone, and poly(ethylene oxide); the water-soluble binder may be used singly or in combination.

The porous type is one coated with a mixture of fine particles and a water-soluble binder, and glossy one is preferred. As the fine particle, alumina or silica is preferred, and one using the silica having a particle diameter of not more than 0.1 μm is practically preferred. As the water-soluble binder, gelatin, poly(vinyl alcohol), polyvinylpyrrolidone, and poly(ethylene oxide) are preferred. The water-soluble binder may be used singly or in combination.

Among these types, the porous type is particularly preferable in the invention since a recording medium having a higher ink-absorbing speed is suitable for the continuous high-speed printing.

The porous type ink-absorbing layer is described below.

The porous layer is principally constituted by soft coagulation of the water-soluble binder and the inorganic fine particles. To form the pores in the layer, various methods such as follows have been known. Examples of such method include a method by which a uniform coating liquid containing two or more kinds of polymer is coated onto a support and the phases of the polymers are separated in the course of drying to form the pores; a method by which a coating liquid containing a solid fine particles and a hydrophilic or hydrophobic resin is coated on a support and dried, and then the dried ink-jet recording medium is immersed in water or a suitable organic solvent to form the pores by dissolving the fine particle; a method by which a coating liquid containing a foaming substance and foams are made from the foaming substance in the course of drying to form the pores in the layer; a method by which a coating liquid containing porous fine solid particles and a hydrophilic binder is coated onto a support so as to form the pores internal of the particle and between the particles; and a method by which a coating liquid containing a hydrophilic binder and the equal or more volume of solid fine particles and/or fine oil droplets is coated onto a support to form the pores between the solid fine particles. In the invention, it is preferred that the porous layer comprises inorganic solid fine particles having an average particle diameter of not more than 100 nm.

Examples of the inorganic fine particle to be used for the above purpose include a white pigment such as light calcium carbonate, heavy calcium carbonate, magnesium carbonate, kaolin, clay, talk, calcium sulfate, barium sulfate, titanium dioxide, zinc oxide, zinc hydroxide, zinc sulfide, zinc carbonate, hydrotalcite, aluminum silicate, diatom earth, calcium silicate, magnesium silicate, synthesized amorphous silica, colloidal silica, alumina, colloidal alumina, pseudoboehmite, aluminum hydroxide, lithopone, zeolite and magnesium hydroxide.

The average diameter of the inorganic fine particle can be determined as the simple average or number average of the diameters of optionally selected of 1,000 particles measured by electronmicroscopic observation on the particle itself or particle appeared to the cross-section or the surface of the porous layer. The diameter of the each particle is represented by the diameter of a circle having the same area as the projection area of the particle.

Solid particle selected from silica, alumina and hydrated alumina is preferable as the inorganic fine particle.

In the invention, silica synthesized by a usual wet method, colloidal silica or silica synthesized by a gas phase method is preferably used. Among them, the colloidal silica or the silica fine particles synthesized by gas phase method is preferable. The silica fine particle synthesized by gas phase method is particularly preferred since high porosity can be obtained by such the silica particle and a coarse aggregation is difficultly formed when the silica particle is added to a cationic polymer for fixing a dye. The alumina and the hydrated alumina may be crystalline or amorphous, and those having any shape such as irregular-shaped, sphere-shaped and needle-shaped particle are usable.

It is preferred that the inorganic particle is dispersed in a state of primary particle in the fine particle dispersion before mixing with the cationic polymer.

The preferable diameter of the inorganic fine particle is not more than 100 nm. In the case of the silica fine particle synthesized by the gas phase method, the average diameter of the primary particle of the inorganic fine particle dispersed in the state of the primary particle, namely the particle diameter in the dispersion before coating, is preferably not more than 100 nm, more preferably from 4 to 50 nm, the most preferably from 4 to 20 nm.

As an example of the most preferable silica synthesized by the gas phase method and having an average particle diameter of from 4 to 20 nm, Aerosil produced by Nihon Aerosil is available in the market. The silica fine particle synthesized by the gas phase method can be easily dispersed until the primary particle by dispersing with suction by, for example, Jet-Stream Inductor Mixer, manufactured by Mitamura Riken Kogyo Co., Ltd.

It is preferred in the invention that the ink-absorbing layer contains a water-soluble binder.

Examples of the water-soluble binder usable in the invention include poly(vinyl alcohol), gelatin, poly(ethylene oxide), polyvinylpyrrolidone, poly(acrylic acid), polyacrylamide, polyurethane, dextran, dextrin, κ-, ι- and λ-carrageenan, agar, pullulan, water-soluble polyvinylbutyral, hydroxyethyl cellulose and carboxymethyl cellulose. Two or more kinds of these water-soluble binders may be used in combination.

The water-soluble binder preferably used in the invention is poly(vinyl alcohol).

The poly(vinyl alcohol) preferably usable in the invention include a modified poly(vinyl alcohol) such as a polyvinyl alcohol cationically modified at the terminal thereof an anionically modified poly(vinyl alcohol) having an anionic group additionally to the usual poly(vinyl alcohol) obtained by hydrolysis of poly(vinyl acetate).

As the poly(vinyl alcohol) obtained by hydrolysis of poly(vinyl acetate), one having an average polymerization degree of not less than 1,000 is preferably used, and one having an average polymerization degree of from 1,500 to 5,000 is particularly preferred. The saponification degree of the poly(vinyl alcohol) is preferably from 70 to 100%, particularly preferably from 80 to 99.5%.

Example of the cationically modified poly(vinyl alcohol) is one having a primary-, secondary- or tertiary-amino group or a quaternary ammonium group at the main chain or a side chain of the poly(vinyl alcohol) such as those described in JP O.P.I. No. 61-10483. The cationically modified poly(vinyl alcohol) can be obtained by saponification of a copolymer of an ethylenic unsaturated monomer having a cationic group and vinyl acetate.

Examples of the ethylenic unsaturated monomer having a cationic group include trimethyl-(2-acrylamido-2,2-dimethylethyl)ammonium chloride, trimethyl-(3-acrylamido-3,3-dimethylpropyl)ammonium chloride, N-vinylimidazole, N-vinyl-2-methylimidazole, N-(3-dimethylaminopropyl)methacrylanide, hydroxylethyltrimethylammonium chloride, trimethyl-(2-methacrylamidopropyl)ammonium chloride and N-(1,1-dimethyl-3-dimethylaminopropyl)acrylamide.

In the cationically modified poly(vinyl alcohol), the ratio of the cationically modified group containing monomer to the vinyl acetate is from 0.1 to 10 mole-%, preferably from 0.2 to 5 mole-%.

Examples of the anionically modified poly(vinyl alcohol) include a poly(vinyl alcohol) having an anionic group such as that described in JP O.P.I. Publication No. 1-206088, a copolymer of vinyl alcohol and a vinyl compound having a water-dissolving group such as that described in JP O.P.I. Publication Nos. 61-237681 and 63-309797, and a modified poly(vinyl alcohol) having a water-dissolving group such as that described in JP O.P.I. Publication No. 7-286265.

Examples of the nonionic modified poly(vinyl alcohol) include a poly(vinyl alcohol) derivative in which a poly(alkylene oxide) is added as a part of poly(vinyl alcohol) such as that described in JP O.P.I. Publication No. 7-9758 and a block copolymer of a vinyl alcohol having a hydrophobic group and vinyl alcohol such as that described in JP O.P.I. Publication No. 8-25795. Two or more kinds of poly(vinyl alcohol) different from each other in the polymerization degree or the modification thereof may be used in combination.

The adding amount of the inorganic fine particle used in the ink-absorbing layer is usually from 5 to 30 g, preferably from 10 to 25 g per square meter of the recording paper even though the amount is strongly depended on the required ink acceptable volume, the porosity of the porous layer, the kind of the inorganic fine particle and the kind of the water-soluble binder.

The weight ratio of the inorganic fine particle to the water-soluble binder is usually from 2:1 to 20:1, preferably from 3:1 to 10:1.

A cationic water-soluble polymer having a quaternary ammonium group may be contained in the recording paper in an amount of usually from 0.1 to 10 g, preferably from 0.2 to 5 g, per square meter of the ink-jet recording paper.

The total volume of the pores in the porous layer is preferably not less than 20 ml per square meter of the recording paper. When the pore volume is less than 20 ml per square meter, problems tend to occur as that the absorption of the ink is made incomplete so as to degrade the image quality and the drying speed is made too slow if the amount of the ink is increased even though the ink is completely absorbed when the amount of the ink is small.

In the porous layer having an ink holding ability, the ratio of the volume of the pores to the volume of the solid constituent is referred to as porosity. In the invention, it is preferred to make the porosity to not less than 50% since the pores are effectively formed without unnecessary excessive thickness of the layer.

A type of the porous layer, other than the ink-absorbing layer formed by using the inorganic particle, can be formed by using a coating liquid of a polyurethane resin emulsion or that of the polyurethane resin emulsion added with a water-soluble epoxy compound and/or acetoacetylated poly(vinyl alcohol) and further epichlorohydrinpolyamide resin. In such the case, the polyurethane resin emulsion is preferably an emulsion of a polyurethane resin having a polycarbonate chain or a polycarbonate chain and a polyester chain and the particle diameter of 3.0 μm. It is more preferable that the resin of the polyurethane resin emulsion is a polyurethane resin obtained by a reaction of a polyol including a polycarbonatepolyol or the polycarbonatepolyol and a polyester polyol with an aliphatic isocyanate compound and the polyurethane resin having a sulfonic acid group, a epichlorohydrinpolyamide resin and a water-soluble epoxy compound and/or acetoacetylated vinyl alcohol in the molecular thereof. It is supposed that a weak coagulum of the anion and the cation is formed in the ink-absorbing layer using such the polyurethane resin, and the pore having the ink solvent absorbing ability is formed accompanied with such the phenomenon so that the image can be formed.

In the invention, the use of a hardener is preferred. The hardener can be added at an optional step of the production of the ink-jet recording medium. It is preferable in the invention that the hardener of the water-soluble binder is supplied after the formation of the ink-absorbing layer even though the hardener may be added into the coating liquid for forming the ink-absorbing layer.

In the invention, the method by which the hardener is supplied after formation of the ink-absorbing layer may be singly applied; however, such the method is preferably applied in combination with a method by which the hardener is added into the coating liquid for forming the ink-absorbing layer.

As the hardener usable in the invention, boric acid and a salt thereof is preferred even though there is no limitation on the hardener as far as the hardener is one capable of occurring a hardening reaction with the water-soluble binder. Known hardeners also can be used other than the boric acid and a salt thereof. In general, the hardener is a compound having a group capable of reacting with the water-soluble binder or a compound capable of accelerating a reaction between the different groups each existing in the water-soluble binder. The hardener is suitably selected according to the kind of the water-soluble binder. Concrete examples of the hardener include an epoxy type hardener such as diglycidyl ethyl ether, ethylene glycol diglycidyl ether, 1,4-butanediol diglycidyl ether, 1,6-diglycidylcyclohexane, N,N-diglycidyl-4-glycidyloxianiline, solbitol polyglycidyl ether and glycerol polyglycidyl ether; an aldehyde type hardener such as formaldehyde and glyoxal; a reactive halogen type hardener such as 2,4-dichloro-4-hydroxy-1,3,5-s-triazine; a reactive vinyl type hardener such as 1,3,5-trisacryloyl-hexahydro-s-triazine and bisvinylsulfonyl methyl ether; and aluminum alum.

The boric acid and a salt thereof are an oxygen acid having a boron atom as the central atom and a salt thereof, concretely orthoboric acid, diboric cid, metaboric acid, tetraboric acid, pentaboric acid and octaboric acid and a salt thereof.

The boric acid and its salt having a boron atom as the hardening agent may be used in a form of solution of single substance or a mixture of two or more kinds of such the substance. A solution of a mixture of boric acid and borax is particularly preferred.

Boric acid and borax each can be added only in a form of a relatively low concentration solution. However, a mixture of both of the compounds can be made a high concentration solution. Moreover, it is an advantage that the pH of the solution can be controlled with a relatively high degree of freedom.

The total using amount of the foregoing hardener is preferably from 1 to 600 mg, more preferably from 100 to 600 mg, per gram of the water-soluble binder.

In the ink-jet recording medium relating to the invention, an inorganic pigment is preferably contained together with the thermoplastic resin in the outer layer.

In the invention, the outer layer, which is not necessarily the outermost layer, is at least a layer arranged at a position farther than the ink-absorbing layer from the support or the ink-absorbing layer itself is the outer layer containing thermoplastic resin. Accordingly, a surface layer may be further provided at the outer side of the outer layer.

Preferable examples of the layer constitution are shown below to clearly demonstrate the outer layer of the invention. However, the layer constitution relating to the invention is not limited thereto.

1: A constitution in which a porous ink-absorbing layer is provided on the support and the outermost layer (the outer layer), containing the thermoplastic resin, or that containing the inorganic pigment and the thermoplastic resin is provided on the ink-absorbing layer.

2: A constitution in which a porous ink-absorbing layer is provided on the support and the outer layer containing the thermoplastic resin, or that containing the inorganic pigment and the thermoplastic resin is provided on the ink-absorbing layer and a thin layer for improving the surface property is further provided on the outer layer.

3: A constitution in which a porous ink-absorbing layer is provided on the support and the outer layer containing the thermoplastic resin, or that containing the inorganic pigment and the thermoplastic resin is provided on the ink-absorbing layer and a thin layer having a UV absorbing ability for cutting a damaging light is further provided on the outer layer.

4: A constitution in which a porous ink-absorbing layer is provided on the support and the outer layer containing the thermoplastic resin, or that containing the inorganic pigment and the thermoplastic resin is provided on the ink-absorbing layer and a thin layer for containing a matting agent is further provided on the outer layer.

5: A constitution in which a porous ink-absorbing layer is provided on the support and the outer layer containing the thermoplastic resin or the inorganic pigment and the thermoplastic resin is provided on the ink-absorbing layer and a peelable layer is further provided on the outer layer.

6: A constitution in which a porous ink-absorbing layer containing the thermoplastic resin or that containing the inorganic pigment and the thermoplastic resin.

Among the foregoing constitution examples, the constitution of the foregoing 1 in which the outer layer containing the thermoplastic resin or that containing the thermoplastic resin and the inorganic pigment is the outermost layer is most preferable since the effect of the invention is exceedingly enhanced.

The outer layer containing the thermoplastic resin or that containing the inorganic pigment and the thermoplastic resin may further contain the water-soluble binder component according to necessity.

The inorganic pigment can be selected from the inorganic particles usable in the porous layer.

Examples of the inorganic pigment include a white pigment such as light calcium carbonate, heavy calcium carbonate, magnesium carbonate, kaolin, clay, talk, calcium sulfate, barium sulfate, titanium dioxide, zinc oxide, zinc hydroxide, zinc sulfide, zinc carbonate, hydrotalcite, aluminum silicate, diatom earth, calcium silicate, magnesium silicate, synthesized amorphous silica, colloidal silica, alumina, colloidal alumina, pseudoboehmite, aluminum hydroxide, lithopone, zeolite and magnesium hydroxide.

As the inorganic pigment, a solid fine particle selected from the silica, alumina and hydrated alumina is preferably used, and the silica is further preferable.

Silica synthesized by a usual wet method, colloidal silica and silica synthesized by a gas phase method are preferably used. Among them, the colloidal silica and the silica fine particle synthesized by gas phase method are preferably used in the invention. The silica fine particle synthesized by gas phase method is particularly preferred since high porosity can be obtained by such the silica particle and a coarse aggregation is difficultly formed when the silica particle is added to a cationic polymer for fixing a dye. The alumina and the hydrated alumina may be crystalline or amorphous, and those having any shape such as irregular-shaped, sphere-shaped and needle-shaped particle are usable. In the invention, the use of the silica or the alumina is preferable, and the use of the silica is more preferable among them.

It is preferred that the inorganic pigment is dispersed until the state of primary particle in the fine particle dispersion before mixing with the cationic polymer.

The preferable diameter of the inorganic pigment is not more than 100 nm. In the case of the silica fine particle synthesized by the gas phase method, the average diameter of the primary particle of the inorganic pigment dispersed in the state of the primary particle, namely the particle diameter in the dispersion before coating, is preferably not more than 100 nm, more preferably from 4 to 50 nm, the most preferably from 4 to 20 nm.

Examples of the thermoplastic resin preferably usable in the invention include a polycarbonate, a polyacrylonitryl, a polystyrene, a poly(acrylic acid), a poly(methacrylic acid), a polyacrylate, a poly(vinyl chloride), a poly(vinylidene chloride), a poly(vinyl acetate), a polyester, a polyamide, a polyether, a copolymer of the above-mentioned and a salt thereof. Among them, a polyacrylate, a styrene-acrylate copolymer, a vinyl chloride-vinyl acetate copolymer, a vinyl chloride-acrylate copolymer, an ethylene-vinyl acetate copolymer, ethylene-acrylate copolymer and SBR latex. As the thermoplastic resin, a mixture of plural kinds of the polymer may be used which different from each other in the monomer constitution, particle diameter or the polymerization degree.

The ink acceptability, the glossiness of the image after fixing by heat and pressure, the fastness of the image and the mold releasing ability have to be considered for the selection of the thermoplastic resin.

As to the ink acceptability, the ink-absorbing speed is degreased when the particle size of the thermoplastic resin is less than 0.05 μm since the separation speed of the pigment particle contained in the ink and the solvent of the ink is reduced in such case. The particle size of the thermoplastic resin exceeding 10 μm is not preferable from the viewpoint of the strength and the glossiness of the ink-jet recording medium after the coating and drying. Accordingly, the diameter of the thermoplastic resin particle is preferably from 0.05 to 10 μm, more preferably from 0.1 to 5 μm, further preferably from 0.1 to 1 μm.

The glass transition point Tg can be referred for selection of the thermoplastic resin. When the Tg of the thermoplastic resin is lower than the temperature at the coating and drying, the pores constituted by the thermoplastic resin for permeating the ink solvent will be lost. When the Tg of the thermoplastic resin is higher than the temperature at which the support is modified by heat, the fixing treatment at a high temperature is necessary for fusing and layer forming after the ink-jet recording. Therefore, problems of the load of the device and the thermal stability of the support are occurred. The Tg of the thermoplastic resin is preferably from 50 to 150° C., more preferably from 60 to 150° C., further preferably from 65 to 100° C.

The thermoplastic resin having the minimum layer forming temperature MFT of from 50 to 150° C. is preferable, and that having the minimum layer forming temperature MFT of from 65 to 130° C. is more preferable.

The thermoplastic resin dispersed in an aqueous system is preferred from the viewpoint of the environmental suitability, and an aqueous latex obtained by emulsion polymerization is particularly preferred. A latex prepared by emulsion polymerization using a nonionic dispersant such as poly(vinyl alcohol) as the protective colloid is preferably used. As the thermoplastic resin, one containing a small amount of the remaining monomer component is preferred from the viewpoint of the odor and the safety. The content of the remained monomer component is preferably not more than 3%, more preferably not more than 1%, further preferably not more than 0.1%, by weight of the solid ingredient of the polymer.

In the case of the outer layer containing the inorganic pigment and the thermoplastic resin, the solid ingredient ratio of thermoplastic resin/inorganic pigment is preferably from 90/10 to 10/90, more preferably from 70/30 to 30/70, particularly preferably from 60/40 to 40/60.

In the invention, the amount of the solid ingredient of the thermoplastic resin contained in the outer layer is preferably from 2 g/m² to 20 g/m², more preferably from 2 g/m² to 15 g/m², particularly preferably from 2.5 g/m² to 10 g/m². When the amount of the solid ingredient of the thermoplastic resin is too small, the layer is not formed sufficiently so that the dye cannot be satisfactorily dispersed in the layer. Consequently, satisfactory image quality and glossiness can be difficultly obtained. When the amount of the solid ingredient of the thermoplastic resin is excessive, the thermoplastic resin cannot be completely made layer in the short duration of the heat treatment, and the resin is remained in a form of the fine particle. As a result of that, the image quality tends to be degraded since the remained resin particle causes turbid of the layer. In such the case, the ink-absorbing speed is also lowered and a problem of occurrence of image spread at the image boundary is occurred some times.

The outer layer coating liquid containing the inorganic pigment and the thermoplastic resin either may be prepared by simultaneously dispersing the inorganic pigment and the thermoplastic resin or mixing the dispersions of them separately prepared at the time of the coating liquid preparation.

The support to be used in the invention can be suitably selected from those usually used in the ink-jet recording paper, for example, a paper support such as ordinary paper, art paper, coated paper and cast-coated paper; a plastic support; a paper support coated on both sides with polyolefin; and a support formed by combination of them.

It is preferred for the recording medium of the invention that the support is subjected to a corona discharge treatment or a subbing treatment in advance to the coating of the ink-absorbing layer to raise the adhesive force of the support to the ink-absorbing layer. It is not always necessary that the support regarding to the invention is colorless; colored recording paper may be used.

In the recording medium according to the invention, the paper support laminated on both sides by a resin such as polyethylene is particularly preferred since a photo-like image and a high quality image can be obtained with a low cost by the use of such the support. The polyethylene laminated paper support is described below.

The raw paper to be used for such the paper support is made using wood pulp as the principal raw material; and synthesized pulp of polypropylene and synthesized fiber of nylon or polyester may be used additionally to the wood pulp according to necessity. As the wood pulp, LBKP, LBSP, NBKP, NBSP, LDP, NDP, LUKP and NUKP may also be used. It is preferable that LBKP, NBSP, LBSP, NDP and LDP each containing many short fibers in a larger amount. The content of LBSP or LDP is preferably from 10% to 70% by weight.

As the foregoing pulp, chemical pulp such as sulfate pulp and sulfite pulp with a little amount of impurity. Bleached pulp raised in the whiteness is also advantageously used. Into the raw paper, an additive, for example, a sizing agent such as a higher fatty acid and an alkylketen dimer; a white pigment such as calcium carbonate, talk, titanium dioxide; a paper strength increasing agent such as starch, polyacrylamide and poly(vinyl alcohol); a UV absorbent; a moisture holding agent such as poly(ethylene glycol); a dispersant; and a softening agent such as a quaternary ammonium may be suitably added. The water filtering degree of the pulp to be used for paper making is preferably from 200 to 500 ml according to the definition of CSF. As to the fiber length of the pulp, it is preferable that the sum of the 24 mesh remaining ingredient and the 42 mesh remaining ingredient defined by JIS-P-8207 is from 30 to 70% by weight. The 4 mesh remaining ingredient is preferably not more than 20% by weight. The weight of the raw paper is preferably from 30 to 250 g/m², more preferably from 50 to 200 g/m². The thickness of the raw paper is preferably from 40 to 250 μm. The raw paper may be given high smoothness by a calender treatment in the course of or after the paper making. The density of the raw paper according to JIS-P-8118 is usually from 0.7 to 1.2 g/cm³. The stiffness of the raw paper is preferably from 20 to 200 g according to the condition defined by JIS-P-8143. A surface sizing agent may be coated on the surface of the raw paper. As the surface sizing agent, those described as the sizing agent to be added to the paper can be used. The pH of the raw paper is preferably from 5 to 9 when the pH is measured by the hot water extraction method defined by JIS-P-8113.

Although the polyethylene covering the both surfaces of the raw paper is mainly composed of low density polyethylene LDPE and/or high density polyethylene HDPE, linear low density polyethylene LLDPE or polypropylene may be partially used. The polyethylene layer on the ink-absorbing layer side is preferably one containing rutile or anatase type titanium oxide for improving the opacity and the whiteness of the polyethylene layer such as that widely used in photographic paper. The content of the titanium oxide is usually from 2 to 30%, preferably from 4 to 13%, by weight of the polyethylene.

The polyethylene laminated paper may be used not only as the glossy paper but also as one having a matted surface or silk surface usually used in photographic paper formed by embossing treatment.

The using amount of polyethylene providing on to the front or rear surface of the raw paper is selected so that the paper has suitable curling after the provision of the porous layer and the backing layer. The thickness of the polyethylene layer of the porous layer side is usually from 20 to 40 μm, and that of the polyethylene layer on the backing side is usually from 10 to 30 μm.

Moreover, the polyethylene laminated paper preferably has the following properties:

1. Tensile strength: Preferably from 20 to 300 N in the longitudinal direction and from 10 to 200 N in the crossing direction by the strength defined by JIS-P-8113

2. Tear strength: Preferably from 0.1 to 20 N in the longitudinal direction and from 2 to 20 N in the crossing direction by the strength defined by JIS-P-8116

3. Compression elastic modulus ≧98.1 MPa

4. Bekk smoothness of surface: preferably not less than 20 seconds for a glossy surface under the condition defined by JIS-P-8119, may be smaller than that for a embossed surface

5. Surface roughness: Preferably the maximum height is not less than 10 μm per standard length of 2.5 mm according to the surface roughness defined by JIS-P-0601.

6. Opacity: Preferably not less than 80%, more preferably from 85 to 98% according to the method defined by JIS-P-8138

7. Whiteness: L*, a* and b* defined by JIS-Z-8729 are each preferably from 80 to 90, from −3 to +5 and from −6 to +2, respectively.

8. Surface glossiness: The mirror surface glossiness at 60° defined by JIS-Z-8741 is preferably from 10 to 95%.

9. Clark stiffness: The support having a Clark stiffness in the conveying direction of from 50 to 300 cm²/100 is preferred.

10: Moisture content of raw paper: Preferably from 2 to 100%, more preferably from 2 to 6%, of the raw paper by weight.

Any inks such as a dye ink, a pigment ink, an aqueous ink, an oily ink and a hot-melt ink may be used to the recording medium according to the invention. Among them, the aqueous dye ink, the aqueous pigment ink and the oily pigment ink are suitable, the aqueous dye ink and the aqueous pigment ink are more suitable and the aqueous pigment ink is most suitable for the recording medium according to the invention.

The production method of the ink-jet recording medium according to the invention is described below.

The ink-jet recording medium can be produced by coating and drying each of the constitution layers separately or simultaneously on the support by a coating method optionally selected from known coating methods. As the coating method, for example, a roller coating method, a rod-bar coating method, an air-knife coating method, spray coating method, a curtain method, a slide-bead coating method using a hopper such as that described in U.S. Pat. Nos. 2,761,419 and 2,761,791 and an extrusion coating method are preferably usable.

The viscosity of each of the coating liquids for simultaneously coating is preferably from 5 to 100 mPa·s, more preferably from 10 to 50 mPa·s when the slide-bead coating method is applied, and preferably from 5 to 1200 mPa·s, more preferably from 25 to 500 mPa·s in the case of the curtain coating method.

The viscosity of each of the coating liquids at 15° C. is preferably not less than 100 mPa·s, more preferably from 100 to 30,000 mPa·s, further preferably from 3,000 to 30,000 mPa·s, and most preferably from 10,000 to 30,000 mPa·s.

As the procedure for coating and drying, it is preferable that the coating liquids are each warmed by 30° C. or more and simultaneously coated on the support, the coated layer is cooled once by a temperature of from 1 to 15° C. and then dried at a temperature of not more than 10° C. The preparation, coating and drying of the coating liquids are preferably performed at a temperature not more than the Tg of the thermoplastic resin so that the layer of the thermoplastic resin is not formed. It is more preferably that the drying is performed under a condition of a wet-bulb temperature of from 5 to 50° C. and a surface temperature of from 10 to 50° C. The cooling just after the coating is preferably performed by a horizontal setting method from the viewpoint of the uniformity of the coated layer.

The producing process of the recording medium according to the invention preferably has a step for supplying the hardener of the water-soluble binder. For supplying the hardener, for example, a method by which a solution containing the hardener is coated after the formation of the ink-absorbing layer and a method by which a solution of the hardener is sprayed to the recording medium surface on which the ink-absorbing layer has been formed can be suitably applied even though there is no limitation on the hardener supplying method.

In the invention, it is preferable that the production process has a step for storing the recording medium for a period of from 24 hours to 60 days at a temperature of from 35° C. to 70° C. in the course of the production. It is not necessary to control the humidity in the process of the storage for a period of from 24 hours to 60 days at a temperature of from 35° C. to 70° C. However, the relative humidity RH at the storing temperature is controlled preferably to a RH of mot more than 80%, more preferably not more than 50%.

The preferable heating condition is the storage for a period of from 24 hours to 60 days at a temperature of from 35° C. to 70° C. A more preferable condition of the heating is storage for a period of from 3 days to 4 weeks at 36° C., from 2 days to 2 weeks at 40° C. or from 1 to 7 days at 55° C. By such the heat treatment, the hardening reaction or the crystallization of the water-soluble binder can be accelerated so as to obtain the suitable ink-absorbing ability of the recording medium.

Next, the ink-jet image forming method according to the invention is described.

The image formed by the ink-jet method according to the invention is obtained by recording to the recording medium by an ink-jet printer. In the invention, it is preferred to fuse the thermoplastic resin contained in the outer layer or to form a film of the thermoplastic resin in the process of the image formation.

In the invention, the status of the fusion or the film formation of the outer layer can be confirmed by electronmicroscopic observation of the surface of the recording medium. Although the status after the fusion or layer formation is influenced by the constitution of the recording medium such as the kind of the thermoplastic resin, the weight ratio of the thermoplastic resin to the inorganic pigment and the layer thickness, and the constitution of the ink. The variation of the status can be confirmed by one or more of the following phenomena. One of them is the change of the shape of the thermoplastic resin; the particle of the resin usually having a sphere shape is made to flat shape or stretched as thread-like shape, moreover, some times, plural particles of the thermoplastic resin are deformed into flat and united. It is preferable that the thermoplastic particles are united so as to partially of completely form a film.

Examples of the method include a method by which an organic solvent capable of fusing the thermoplastic resin is provided to the image by a means such as an ink-jet head and a method for fusing or film forming of the resin by heating. It is more preferable that pressure is further applied additionally to each of the foregoing methods. Among the foregoing method, the method by heating is preferable and the method by simultaneously applying the heat and pressure is further preferable.

An aqueous ink composition, an oily ink composition and a solid or phase changing ink composition can be used as the ink to be used for the image formation. The aqueous ink composition such as an aqueous ink-jet recording liquid containing water in an amount of not less than 10% by weight of the total weight of the ink is particularly preferably used.

A water-soluble dye such as an acid dye, a direct dye, a reactive dye, a dispersion dye and a pigment can be used as the colorant of the ink.

In the invention, the use of the pigment ink is particularly preferable from the viewpoint of the storage ability of image. An insoluble pigment, an organic pigment such as a lake pigment, and carbon black are preferably used as the pigment of the pigment ink.

As the insoluble pigment, even though the pigment is not limited, azo, azomethine, methine, diphenylmethane, triphenylmethane, quinacridone, anthraquinone, perylene, indigo, quinophthalone, isoindolinone, azine, oxazine, thiazine, dioxazine, thiazole, phthalocyanine and diketopyrrolopyrrol are preferably used.

Concrete examples of preferably usable pigment are the followings. Examples of magenta or red pigment include C.I. Pigment Red 2, C.I. Pigment Red 3, C.I. Pigment Red 5, C.I. Pigment Red 6, C.I. Pigment Red 7, C.I. Pigment Red 15, C.I. Pigment Red 16, C.I. Pigment Red 48:1, C.I. Pigment Red 53:1, C.I. Pigment Red 57:1, C.I. Pigment Red 122, C.I. Pigment Red 123, C.I. Pigment Red 139, C.I. Pigment Red 144, C.I. Pigment Red 149, C.I. Pigment Red 166, C.I. Pigment Red 177, C.I. Pigment Red 178 and C.I. Pigment Red 222.

Examples of orange or yellow pigment include C.I. Pigment Orange 31, C.I. Pigment Orange 43, C.I. Pigment Yellow 12, C.I. Pigment Yellow 13, C.I. Pigment Yellow 14, C.I. Pigment Yellow 15, C.I. Pigment Yellow 17, C.I. Pigment Yellow 74, C.I. Pigment Yellow 93, C.I. Pigment Yellow 94 and C.I. Pigment Yellow 138.

Examples of green or cyan pigment include C.I. Pigment Blue 15, C.I. Pigment Blue 15:2, C.I. Pigment Blue 15:3, C.I. Pigment Blue 16, C.I. Pigment Blue 60 and C.I. Pigment Green 7.

A pigment dispersant may be used for these dyes according to necessity. Examples of the pigment dispersant include a surfactant such as a higher fatty acid salt, an alkylsulfate, an alkylestersulfate, an alkylsulfonate, a sulfosuccinate, a naphthalenesulfonate, an alkylphosphate, a polyoxyalkylene alkyl ether phosphate, polyoxyalkylene alkylphenyl ether, a polyoxyethylene polyoxypropylene glycol, a glycerol ester, a solbitol ester, a polyoxyethylene aliphatic amide and an amine oxide or a block copolymer, a random copolymer and a salt thereof, which is comprised of two or more monomers selected from the group consisting of styrene, a styrene derivative, a vinylnaphthalene derivative, acrylic acid, an acrylic acid derivative, maleic acid, a maleic acid derivative, itaconic acid, an itaconic acid derivative, fumaric acid and a fumaric acid derivative.

Various dispersing machine such as a ball mill, a sand mill, an attritor, a role mill, an agitator, a Henschel mixer, a colloid mill, an ultrasonic homogenizer, pearl mill, a wet jet mill and a paint shaker can be used for dispersing the pigment. Moreover, a centrifugal separator or a filter is preferably used for removing coarse particles in the pigment dispersion.

The average diameter of the pigment particles in the pigment ink is selected on the consideration about the stability, image density, glossiness and light-fastness of the pigment in the ink. Moreover, it is preferable in the invention to select the particle diameter from the viewpoint of rising of the glossiness and the textile feeling. It is supposed that the rising of the glossiness and the textile feeling is caused by the suitable dispersed state of the pigment particle in the fused layer of the thermoplastic resin of the formed image even though the reason such the improvement is not cleared yet. When the high-speed processing is the object, the thermoplastic resin should be rapidly fused and made to a layer and the pigment has to be satisfactorily dispersed in the resin layer. It is considered that there is a most suitable range of the average particle diameter since the surface area of the pigment particle is remarkably influences on the dispersion of the pigment particle.

It is preferred that a water-soluble organic solvent is contained in the aqueous ink composition as the preferable embodiment of the pigment ink. Examples of the water-soluble solvent include an alcohol such as methanol, ethanol, propanol, iso-propanol, butanol, iso-butanol, secondary butanol, tertiary butanol, pentanol, hexanol, cyclohexanol and benzyl alcohol; a polyvalent-alcohol such as ethylene glycol, diethylene glycol, triethylene glycol, polyethylene glycol, propylene glycol, dipropylene glycol, polypropylene glycol, butylenes glycol, hexanediol, pentanediol, glycerol, hexanetriol and thiodiglycol; a polyvalent-alcohol ether such as ethylene glycol monomethyl ether, ethylene glycol monoethyl ether, ethylene glycol monobutyl ether, diethylene glycol monomethyl ether, diethylene glycol monoethyl ether, diethylene glycol monobutyl ether, propylene glycol monomethyl ether, propylene glycol monombutyl ether, ethylene glycol monomethyl ether acetate, triethylene glycol monomethyl ether, triethylene glycol monoethyl ether, triethylene glycol monobutyl ether, ethylene glycol monophenyl ether, propylene glycol monophenyl ether; an amine such as ethanolamine, diethanol amine, triethanolamine, N-methyldiethanol amine, N-ethyldiethanolamine, morpholine, N-ethylmorpholine, ethylenediamine, diethylenediamine, triethylenetetramine, tetrethylenpentamine, polyethyleneimine, pentamethyldiethylenetriamine and tetramethylpropylenediamine; an amide such as formamide, N,N-dimethylformamide and N,N-dimethylacetoamide; a heterocyclic compound such as 2-pyrrolidone, N-methyl-2-pyrrolidone, cyclohexylpyrrolidone, 2-oxazolidone and 1,3-dimethyl-2-imidazolidinone; a sulfoxide such as dimethylsuofoxide; a sulfone such as sulfolane; urea; acetonitrile and acetone.

The water-soluble organic solvent may be used singly or in combination of plural kinds thereof. The added amount of the water-soluble organic solvent to the ink is from 5 to 60%, preferably from 10 to 35%, by weight in total.

Various know additives such as a viscosity controlling agent, a surface tension controlling agent, a relative electro-resistance controlling agent, a layer forming agent, a dispersant, a surfactant, a UV absorbent, a anti-oxidant, a discoloration preventing agent, an anti-mould agent and a rust preventive may be added to the ink composition corresponding to the object of improving the properties of the ink such as the spouting stability, the suitability to a print head or a cartridge, the storage stability and the image stability. Examples of the additive include an organic latex fine particle of polystyrene, a polyacrylate, a polymethacrylate, a polyacrylamide, polyethylene, polypropylene, poly(vinyl chloride), poly(vinylidene chloride) and a copolymer thereof, a urea resin, or a melamine resin; a fine droplet of an oil such as liquid paraffin, dioctyl phthalate, tricresile phosphate or a silicone oil; various kinds of cationic or nonionic surfactant, a UV absorbent described in JP O.P.I. Publication Nos. 57-74193, 57-87988 and 62-261476; a discoloration preventing agent described in JP O.P.I. Publication Nos. 57-74192, 57-87989, 60-72785, 61-146591, 1-95091 and 3-13376; a fluorescent whitening agent described in JP O.P.I. Publication Nos. 59-42993, 59-52689, 62-280069, 61-242871, and 4-219266; and a pH controlling agent such as sulfuric acid, phosphoric acid, citric acid, sodium hydroxide, potassium hydroxide and potassium carbonate.

The viscosity of the ink composition at the time of flying is preferably not more than 40 mPa·s, more preferably not more than 30 mPa·s. The surface tension of the ink composition at the time of flying is preferably not less than 20 mN/m, more preferably from 30 to 45 mN/m.

In the preferable embodiment of the invention, the thermoplastic resin contained in the outer layer is fused or formed into a film by the heat treatment after the image recording. The heat treatment is performed to raise the image quality such as the textile feeling, the glossiness and the reduced bronzing and to raise the resistance against friction by fusing and forming a film of the thermoplastic resin in the recording medium. It is demanded in the heat treatment to give sufficient heat necessary to almost completely fuse or to form the film. On the other hand, it is demanded that the heat treatment is performed in a short duration for shortening the processing time. Accordingly, the fusion of the thermoplastic resin and the film formation of thereby may be incomplete unless the substantial difference of the image quality is appeared.

It is desirable to use a heat source with a temperature as higher as possible to provide a sufficient heat amount in the short duration. However, damage of the support, considerable curling, roughing of the image surface and contamination of the roller are caused when the temperature is made excessively higher. The temperature is preferably within the range of from 100 to 200° C., more preferably from 100 to 150° C.

The heating may be performed by a heating device built-in the printer or a separated device. As the heating means, a heating roller is suitable for preventing formation of unevenness of image and continuous treatment in a small space. Diversionary use of the heat fixing device for an electrophotographic machine is advantageous for reducing the coast. As the heat treatment method, for example, a method by which the recording medium is passed between a heating roller and a pressing roller for applying heat and pressure to the recording medium, a method by which the recording medium is inserted between two heating rollers, and a method by which a fixing belt is provided between a pare of heating rollers for the heat treatment are applicable.

The heating roller is constituted by a hollow roller and rotated by a driving means. A heating member such as a halogen lump heater, a ceramic heater or a nichrome heater is built in the hollow of the roller. The roller is preferably one made from a material with high heat conductivity; a metal roller is particularly preferred. The surface of the roller is preferably coated with a fluorocarbon resin to prevent contamination. Further, a silicone rubber roller covered with heat resistive silicone can be used.

The conveying speed of the recording medium is preferably within the range of from 1 to 15 mm/second when the heating roller is applied. It is found that such the condition is preferable from the viewpoint of the image quality improvement additionally to the viewpoint of the high speed treatment. For obtaining high textile feeling and glossiness, it is preferable to apply pressure at the same time or just after the heating. Pressure within the range of from 9.8×10⁴ to 4.9×10⁶ Pa is preferred as the pressure to be applied since the layer formation of the thermoplastic resin is accelerated by the pressure.

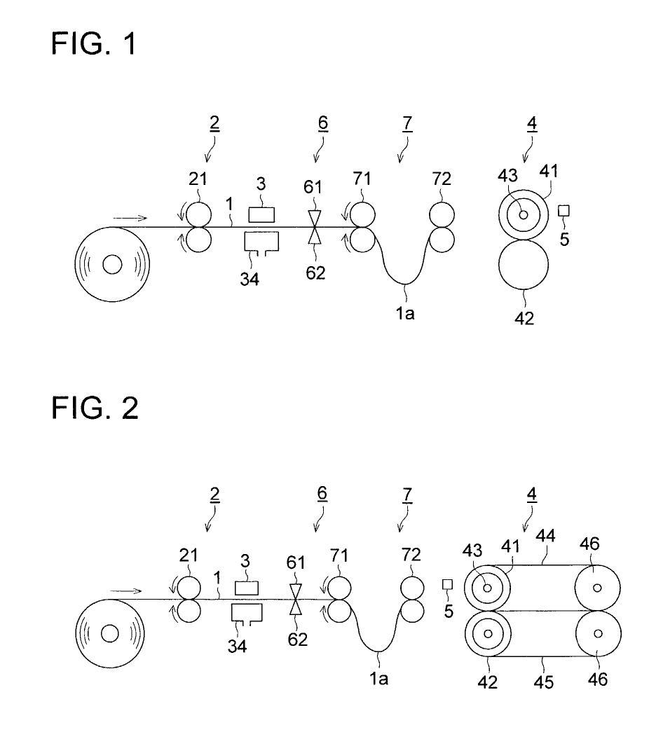

FIG. 1 shows an example of the ink-jet recording apparatus usable in the invention which has the heating roller. FIG. 2 shows an example of the ink-jet recording apparatus usable in the invention which has the heating belt.

The printer to be used for forming an ink-jet image formation according to the invention is described below.

A printer is usable in the invention without any limitation as far as the printer has, for example, a recording medium storing portion, a conveying means, an ink cartridge, and a ink-jet printing head such as those in a printer available in the market. However, the printer is preferably a series of printer set at least constituted by the storing portion for a roll of the recording medium, the conveying means, the ink-jet printing head, a heating means, a cutting means and a recorded print storing portion. The recording head may be one according to a piezo method, thermal method or a continuous method; and the piezo method is preferred from the viewpoint of the stability for the pigment ink.

### EXAMPLES

The invention is described referring the examples below. The invention is not limited to the examples.

### Example 1

<Preparation of Ink-Jet Recording Medium>

An ink-jet recording medium was prepared according to the following procedure.

[Preparation of Dispersion of Inorganic Fine Particle]

Preparation of Silica Dispersion 1

In 215 l of purified water adjusted to a pH value of 2.5 by nitric acid, 125 kg of silica prepared by a gas phase method with an average primary particle diameter of 0.03 μm, Aerosil 50 produced by Nihon Aerosil Co., Ltd., was dispersed with suction at the room temperature by Jet-stream Inductor Mixer TDS, manufactured by Mitamura Riken Kogyo Co., Ltd., and then the dispersion was finished to prepare Silica Dispersion 1 having a solid concentration of 40 weight/volume-%.

Preparation of Silica Dispersion 2

In 27.2 kg of ion-exchanged water, 0.56 kg of cationic polymer P-1 was dissolved and 63.0 l of the foregoing Silica Dispersion 1 was added while stirring, and then 8.8 l of 6% boric acid aqueous solution and 1 g of defoaming agent SN381 produced by Sannopco Co., Ltd., were further added. The mixture was dispersed by a high pressure homogenizer, manufactured by Sanwa Kogyo, Co., Ltd., after adjusting the pH of the mixture to 4.4 by a 6% nitric acid aqueous solution. The dispersion was made up to 99.7 l to prepare Silica Dispersion 2.

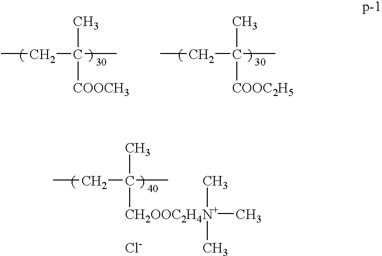

Mn (number-average molecular weight)=13,000

Preparation of Silica Dispersion 3

In 620 l of purified water adjusted to a pH value of 2.5 by nitric acid, 125 kg of silica prepared by a gas phase method with an average primary particle diameter of 0.012 μm, QS-20 produced by Tokuyama Co., Ltd., was dispersed with suction at the room temperature by Jet-stream Inductor Mixer TDS, manufactured by Mitamura Riken Kogyo Co., Ltd., and then the dispersion was finished to 694 l in total to prepare Silica Dispersion 3.

Preparation of Silica Dispersion 4

To 18 l of an aqueous solution containing 1.14 kg of the foregoing cationic surfactant P-1, 2.2 l of ethanol and 1.5 l of propanol, the pH of which was adjusted to 2.3, 69.4 l of the above-prepared Silica Dispersion 3 was added while stirring, and then 7.0 l of an aqueous solution containing 260 g of boric acid and 230 g of borax, and 1 g of the deforming agent SN381 produced by Sannopco Co., Ltd., were further added. The mixture was dispersed by the high pressure homogenizer, manufactured by Sanwa Kogyo, Co., Ltd. The dispersion was made to 97 l to prepare Silica Dispersion 4.

[Preparation of Thermoplastic Resin Coating Liquid]

Preparation of Thermoplastic Resin Coating Liquid 1

The pH of a styrene-acryl polymer latex having a Tg of 78° C., an average particle diameter of 0.3 μm and a solid content of 40%, prepared by emulsion polymerization using a nonionic surfactant was adjusted to 4.7 by a 6% aqueous solution of nitric acid. This liquid was referred to as Thermoplastic Resin Coating Liquid 1.

Preparation of Thermoplastic Resin Coating Liquid 2

The pH of a styrene-acryl polymer latex having a Tg of 78° C., an average particle diameter of 0.5 μm and a solid content of 40%, prepared by emulsion polymerization using a nonionic surfactant was adjusted to 4.7 by a 6% aqueous solution of nitric acid. This liquid was referred to as Thermoplastic Resin Coating Liquid 2.

Preparation of Thermoplastic Resin Coating Liquid 3

The pH of a styrene-acryl polymer latex having a Tg of 78° C., an average particle diameter of 0.8 μm and a solid content of 40%, prepared by emulsion polymerization using a nonionic surfactant was adjusted to 4.7 by a 6% aqueous solution of nitric acid. This liquid was referred to as Thermoplastic Resin Coating Liquid 3.

[Preparation of Another Coating Liquid]

Various coating liquids were each prepared as follows and filtered by filter paper available in the market, TCP 10 or TPC 30 produced by Toyo Filter Paper Co., Ltd.

Preparation of Lower Layer Coating Liquid 1

To 710 ml the above-prepared Silica Dispersion 2, the following additives were added in sequence while stirring at 40° C. to prepare Lower Layer Coating Liquid 1.

A 10% aqueous solution of poly(vinyl alcohol) PVA 203,

| | |
|---|---|
| produced by Kraray Co., Ltd. | 3 ml |

A aqueous solution containing 4.8% of poly(vinyl alcohol) PVA 235, produced by Kraray Co., Ltd., and 1.84% of poly(vinyl alcohol) having an average polymerization degree of 4,500 and an average saponification degree of

| | |
|---|---|
| 89.0% | 273 ml |
| Purified water to make | 1,000 ml |

Preparation of Lower Layer Coating Liquid 2

To 710 ml the above-prepared Silica Dispersion 4, the following additives were added in sequence while stirring at 40° C. to prepare Lower Layer Coating Liquid 2.

A 10% aqueous solution of poly(vinyl alcohol) PVA 203,

| | |
|---|---|
| produced by Kraray Co., Ltd. | 3 ml |

A aqueous solution containing 4.8% of poly(vinyl alcohol) PVA 235, produced by Kraray Co., Ltd., and 1.84% of poly(vinyl alcohol) having an average polymerization degree of 4,500 and an average saponification degree of

| | |
|---|---|
| 89.0% | 273 ml |
| Purified water to make | 1,000 ml |

Preparation of Outer Layer Coating Liquid 1

The above-prepared Thermoplastic Resin Coating Liquid 1 was used as Outer Layer Coating Liquid 1.

Preparation of Outer Layer Coating Liquid 2

The above-prepared Thermoplastic Resin Coating Liquid 2 was used as Outer Layer Coating Liquid 2.

Preparation of Outer Layer Coating Liquid 3

The above-prepared Thermoplastic Resin Coating Liquid 3 was used as Outer Layer Coating Liquid 3.

Preparation of Outer Layer Coating Liquid 4

The above-prepared Thermoplastic Resin Coating Liquid 1 and Lowere Layer Coating Liquid 2 were mix so that the solid ratio of the thermoplastic resin to the inorganic pigment was made to 40:60 and water was added to make the viscosity of the liquid at 43° C. to 45 mPa·s. Thus obtained liquid was referred to as Outer Layer Coating Liquid 4.

Preparation of Outer Layer Coating Liquid 5

Outer Layer Coating Liquid 5 was prepared in the same manner as in Outer Layer Coating Liquid 4 except that the solid ratio of the thermoplastic resin to the inorganic pigment was changed to 60:40.

Preparation of Outer Layer Coating Liquid 6

Outer Layer Coating Liquid 6 was prepared in the same manner as in Outer Layer Coating Liquid 4 except that the solid ratio of the thermoplastic resin to the inorganic pigment was changed to 50:50.

Preparation of Upper Layer Coating Liquid 7

Outer Layer Coating Liquid 7 was prepared in the same manner as in Outer Layer Coating Liquid 4 except that the solid ratio of the thermoplastic resin to the inorganic pigment was changed to 30:70.

Preparation of Outer Layer Coating Liquid 8

A dispersion of alumina was prepared by dispersing 100 parts of hydrated alumina, Cataloid AS-3 produced by Shokubai Kasei Co., Ltd., and 30 parts of poly(vinyl alcohol), PVA177 produced by Kraray Co., Ltd. Outer Layer Coating Liquid 1 was mixed with the above-prepared alumina dispersion so that the solid ratio of the thermoplastic resin to the alumina was 70:30. Thus Outer Layer Coating Liquid 8 was prepared. The average particle size of the thermoplastic resin contained in Outer Layer Coating Liquid 1 was 0.3 μm.

Preparation of Outer Layer Coating Liquid 9

Outer Layer Coating Liquid 9 was prepared in the same manner as in Outer Layer Coating Liquid 8 except that the average particle size of the thermoplastic resin and solid ratio of the thermoplastic resin to the alumina were each changed to 0.40 μm and 40:60, respectively.

[Preparation of Ink-Jet Recording Medium]

Preparation of Sample 1

Outer Layer Coating Liquid 1 was coated on Ink-Jet Paper Photo-like QP, produced by Konica Corp., hereinafter referred to as Photo-Like PQ, by a wire bar and dried so that the amount of the solid component of the thermoplastic resin was 2.0 g/m². The coating liquid was heated by 40° C. and coated. The coated layer was cooled for 20 seconds in a cooling zone held at 0° C. just after the coating, and then consequently dried by air at 25° C. and relative humidity HR of 15% for 60 seconds, at 45° C. and RH of 25% for 60 seconds and at 50° C. and RH of 25% for 60 seconds, and conditioned in an atmosphere at a temperature of from 20 to 25° C. and a RH of from 40 to 60% for 2 minutes. Thus Sample 1 was prepared.

Preparation of Sample 2

Sample 2 was prepared in the same manner as in Sample 1 except that a boric acid solution was overcoated after the coating of the outer layer so that the coated amount of boric acid was 1 g/m².

Preparation of Sample 3

Sample 3 was prepared in the same manner as in Sample 2 except that the solid amount of the thermoplastic resin was changed to 1.8 g/m².

Preparation of Sample 4

Sample 4 was prepared in the same manner as in Sample 1 except that Outer Layer Coating Liquid 1 was replaced by Outer Layer Coating Liquid 2 in which the average particle diameter of the thermoplastic resin was 0.5 μm, and the coated and dried sample was closed in a polyethylene bag and subjected to an aging treatment at 55° C. for 3 days.

Preparation of Sample 5

Paper support laminated by polyethylene layer on both of the surface so called as RC paper was used. The thickness of the support was 220 μm and the polyethylene layer laminated on the surface of the support on which the ink-absorbing layer to be coated contained anatase type titanium oxide in amount of 13% by weight of the polyethylene. Outer Layer Coating Liquid 1 as the first layer and Outer Layer Coating Liquid 3 as the second layer were simultaneously coated on the support in this order from the support by a slide hopper coater and dried. The wet thickness of the first layer was 200 μm and the coated amount of solid component of the thermoplastic resin in the second layer was 2.0 g/m². The average particle diameter of the thermoplastic resin in Outer Layer Coating Liquid 3 was 0.8 μm. The coated layers were cooled for 20 seconds in a cooling zone held at 0° C. just after the coating, and then consequently dried by air at 25° C. and relative humidity HR of 15% for 60 seconds, at 45° C. and RH of 25% for 60 seconds and at 50° C. and RH of 25% for 60 seconds, and conditioned in an atmosphere at a temperature of from 20 to 25° C. and a RH of from 40 to 60% for 2 minutes, and the dried sample was wound up. Thus Sample 5 was prepared.

Preparation of Sample 6

Sample 6 was prepared in the same manner as in Sample 5 except that Lower Layer Coating Liquid 2 was coated as the first layer coating liquid and Outer Layer Coating Liquid 4 was coated as the second layer coating liquid; and the a boric acid solution was overcoated on the surface of the outer layer after the coating of the layers so as to the coated amount was 1 g/m². The wet thickness of the first layer and the second layer were each 140 μm and 60 μm, respectively, and the amount of the solid component of the thermoplastic resin was 3.0 g/m².

Preparation of Sample 7

Sample 7 was prepared in the same manner as in Sample 5 except that except that Lower Layer Coating Liquid 2 was coated as the first layer coating liquid and Outer Layer Coating Liquid 4 was coated as the second layer coating liquid; and the coated and dried sample was closed in a polyethylene bag and subjected to an aging treatment at 55° C. for 3 days. The wet thickness of the first layer and the second layer were each 140 μm and 60 μm, respectively, and the amount of the solid component of the thermoplastic resin was 3.0 g/m².

Preparation of Samples 8 Through 13

Samples 8 through 13 were prepared in the same manner as in Sample 7 except that the wet thickness of the first layer and the kind of Outer Layer Coating Liquid, the wet thickness and the content of the solid composition of the thermoplastic resin of the second layer were changed as given in Table 1.

Preparation of Sample 14

Sample 14 was prepared in the same manner as in Sample 13 except that the first layer was omitted so that the layer was constituted only by the second layer as shown in Table 1.

Preparation of Sample 15

Sample 15 was prepared in the same manner as in Sample 7 except that the support was replaced by water absorbable paper or raw paper for coat paper having a thickness of 165 μm, which was referred to as paper support.

Preparation of Sample 16

Sample 16 was prepared in the same manner as in Sample 7 except that the support was replaced by a white polyethylene terephthalate support having a thickness of 100 μm, which was referred to as PET.

TABLE 1

| | | First layer | | |
|---|---|---|---|---|
| Recording medium | | Wet layer thickness | Lower layer coating | Inorganic fine |
| No. | Support | (μm) | liquid No. | particle |
| 1 | Photo-like PQ | | | |
| 2 | Photo-like PQ | | | |
| 3 | Photo-like PQ | | | |
| 4 | Photo-like PQ | | | |
| 5 | RC paper | 200 | 1 | Aerosil 50 |
| 6 | RC paper | 140 | 2 | QS-20 |
| 7 | RC paper | 140 | 2 | QS-20 |
| 8 | RC paper | 172 | 2 | QS-20 |
| 9 | RC paper | 100 | 2 | QS-20 |
| 10 | RC paper | 160 | 2 | QS-20 |
| 11 | RC paper | 184 | 2 | QS-20 |
| 12 | RC paper | 162 | 2 | QS-20 |
| 13 | RC paper | 170 | 2 | QS-20 |
| 14 | RC paper | — | — | — |
| 15 | Paper | 140 | 2 | QS-20 |
| | support | | | |
| 16 | PET | 140 | 2 | QS-20 |

| | Second layer | | | | | | | |
|---|---|---|---|---|---|---|---|---|
| | | | | Particle diameter | | | | |
| | | Upper | | of thermoplastic | | | | |
| | | layer | | resin (μm) | | | | Ag- |
| Recording | Wet layer | coating | | Particle | Adding | Lx/ | Overcoat | ing |
| medium | thickness | liquid | Inorganic | diameter | amount | Inorganic | of | treat- |
| No. | (μm) | No. | pigment | (μm) | (g/m²) | pigment | hardener | ment |
| 1 | — | 1 | — | 0.3 | 2.0 | — | No | No |
| 2 | — | 1 | — | 0.3 | 2.0 | — | Yes | No |
| 3 | — | 1 | — | 0.3 | 1.8 | — | Yes | No |
| 4 | — | 2 | — | 0.5 | 2.0 | — | No | Yes |
| 5 | — | 3 | — | 0.8 | 2.0 | — | No | No |
| 6 | 60 | 4 | QS-20 | 0.3 | 3.0 | 40/60 | Yes | No |
| 7 | 60 | 4 | QS-20 | 0.3 | 3.0 | 40/60 | No | Yes |
| 8 | 60 | 4 | QS-20 | 0.3 | 3.0 | 40/60 | No | Yes |
| 9 | 60 | 4 | QS-20 | 0.3 | 3.0 | 40/60 | No | Yes |
| 10 | 40 | 5 | QS-20 | 0.3 | 3.0 | 60/40 | No | Yes |
| 11 | 40 | 6 | QS-20 | 0.3 | 2.5 | 50/50 | No | Yes |
| 12 | 70 | 7 | QS-20 | 0.3 | 2.625 | 30/70 | No | Yes |
| 13 | 30 | 8 | Alumina | 0.3 | 2.625 | 70/30 | No | Yes |
| 14 | 200 | 9 | Alumina | 0.4 | 9.6 | 40/60 | No | Yes |
| 15 | 60 | 4 | QS-20 | 0.3 | 3.0 | 40/60 | No | Yes |
| 16 | 60 | 4 | QS-20 | 0.3 | 3.0 | 40/60 | No | Yes |

<Measurements of Properties of Ink-Jet Recording Medium>

[Measurement of Transfer Amount of Ink: Bristow Method]

Each of the samples was stood for 12 hours in the atmosphere of a temperature of 25° C. and a relative humidity of 50% and then the transfer amount of ink the sample was measured by a dynamic liquid absorbing ability testing machine Bristow testing machine II (pressure applying type), manufactured by Kumagaya Riki Kogyo Co., Ltd. The foregoing aqueous magenta ink was used as the liquid for measurement. The area dyed by magenta on the sample was measured for the time of 40 milliseconds after the contact of the ink to the sample. Moreover, the transfer amount of ink was measured for the contacting time of 200 milliseconds after the contact of the ink to the sample in the same manner as in the above.

[Measurement of Water-Absorbing Amount]

Each of the samples having a size of 80 mm×100 mm was conditioned for 24 hours in the atmosphere of a temperature of 25° C. and a relative humidity of 50% and then immersed in purified water for 10 seconds. During the immersion, the sample was suitably vibrated to remove bubbles formed by air included in the pores of the sample since the bubbles adhered onto the surface of the sample inhibit the water absorption by the sample. After 10 seconds, the sample was taken out from the water and the water adhered on the sample surface was quickly removed by filter paper. The weight of the sample was measured before and after the immersion and the amount of absorbed water was defined by the difference of the weight of the sample measured before and after the immersion. The properties of each sample thus measured are shown in Table 2.

TABLE 2

| | | Transfer | | |
|---|---|---|---|---|
| | Transfer | amount of | | |
| | amount of | ink after | Water- | |
| Recording | ink after 40 | 200 | absorbing | |
| medium | milliseconds | milliseconds | amount | |
| No. | (ml/m²) | (ml/m²) | (ml/m²) | Remarks |
| 1 | 7 | 13 | 23 | Comparative |
| 2 | 11 | 16 | 23 | Inventive |
| 3 | 11 | 16 | 23 | Inventive |
| 4 | 11 | 16 | 23 | Inventive |
| 5 | 12 | 17 | 22 | Inventive |
| 6 | 13 | 19 | 25 | Inventive |
| 7 | 14 | 21 | 25 | Inventive |
| 8 | 15 | 24 | 29 | Inventive |
| 9 | 13 | 16 | 20 | Inventive |
| 10 | 13 | 21 | 25 | Inventive |
| 11 | 14 | 21 | 28 | Inventive |
| 12 | 14 | 21 | 29 | Inventive |
| 13 | 13 | 19 | 25 | Inventive |
| 14 | 12 | 15 | 24 | Inventive |
| 15 | 14 | 21 | 25 | Inventive |
| 16 | 14 | 21 | 25 | Inventive |

Evaluation of Crack Occurrence

Each of the samples having an area of 0.3 m² was heated at 55° C. for 3 days in an absolutely dried state and then stood for 3 days for cooling. A fine crack formed on the surface of the ink-absorbing layer was visually observed directly and through a loupe. The results of the observation were ranked according to the following norms.

5: No cracks is observed

4: No cracks can be observed by the visual observation even though from 1 to 5 extremely fine cracks are formed.

3: No cracks can be observed by the visual observation even though 6 or more extremely fine cracks are formed.

2: Fine cracks visible by the visual observation are formed on the whole surface of the sample.

1: Some large cracks are made by connection of cracks.

Results of the evaluation are shown in Table 3.

### Example 2

[Preparation of Ink]

Preparation of Aqueous Ink

Preparation of Pigment Dispersion

Preparation of Yellow Pigment Dispersion 1

| | |
|---|---|
| C.I. Pigment Yellow 74 | 20% by weight |

Styrene-acrylic acid copolymer (molecular weight: 10,000,

| | |
|---|---|
| acid value: 120) | 12% by weight |
| Diethylene glycol | 15% by weight |
| Ion-exchanged water | 53% by weight |

The above components were mixed and dispersed by a horizontal type beads mill System Zeta Mini, manufactured by Ashizawa Co., Ltd., which was filled by 60% by volume of zirconia beads having an average diameter of 0.3 mm. Thus Yellow Pigment Dispersion 1 was prepared. The average diameter of the yellow pigment was 112 nm.

Preparation of Magenta Pigment Dispersion 1

| | |
|---|---|
| C.I. Pigment red 112 | 25% by weight |

Johncryl 61 (Acryl-styrene resin, Johnson Co., Ltd.) 18% by weight in terms of solid ingredient

| | |
|---|---|
| Diethylene glycol | 15% by weight |
| Ion-exchanged water | 42% by weight |

The above components were mixed and dispersed by a horizontal type beads mill System Zeta Mini, manufactured by Ashizawa Co., Ltd., which was filled by 60% by volume of zirconia beads having an average diameter of 0.3 mm. Thus Magenta Pigment Dispersion 1 was prepared. The average diameter of the magenta pigment was 105 nm.

Preparation of Cyan Pigment Dispersion 1

| | |
|---|---|
| C.I. Pigment Blue 15:3 | 25% by weight |
| Johncryl 61 (Acryl-styrene resin, | 15% by weight |
| Johnson Co., Ltd.) | in terms of solid ingredient |
| Glycerol | 10% by weight |
| Ion-exchanged water | 50% by weight |

The above components were mixed and dispersed by a horizontal type beads mill System Zeta Mini, manufactured by Ashizawa Co., Ltd., which was filled by 60% by volume of zirconia beads having an average diameter of 0.3 mm. Thus Cyan Pigment Dispersion 1 was prepared. The average diameter of the cyan pigment was 87 nm.

Preparation of Black Pigment Dispersion 1

| | |
|---|---|
| Carbon black | 20% by weight |
| Styrene-acrylic acid copolymer | 10% by weight |
| (molecular weight: 7,000, | |
| acid value: 150) | |
| Glycerol | 10% by weight |
| Ion-exchanged water | 60% by weight |

The above components were mixed and dispersed by a horizontal type beads mill System Zeta Mini, manufactured by Ashizawa Co., Ltd., which was filled by 60% by volume of zirconia beads having an average diameter of 0.3 mm. Thus Black Pigment Dispersion 1 was prepared. The average diameter of the black pigment was 75 nm.

Preparation of Pigment Ink

Preparation of High Color Density Yellow Ink 1

| | |
|---|---|
| Yellow Pigment Dispersion 1 | 15% by weight |
| Ethylene glycol | 20% by weight |
| Diethylene glycol | 10% by weight |
| Surfactant (Surfinol 465, | 0.1% by weight |
| Nishin Kagaku Kogyo Co., Ltd.) | |
| Ion-exchanged water | 54.9% by weight |

The above components were mixed and stirred, and filtered by a 1 μm. Thus an aqueous pigment ink according to the invention, High Color Density Yellow Ink 1, was prepared. The average particle diameter of the pigment in the ink was 120 nm and the surface tension of the ink was 36 mN/m.

Preparation of Low Color Density Yellow Ink 1

| | |
|---|---|
| Yellow Pigment Dispersion 1 | 3% by weight |
| Ethylene glycol | 25% by weight |
| Diethylene glycol | 10% by weight |
| Surfactant (Surfinol 465, | 0.1% by weight |
| Nishin Kagaku Kogyo | |
| Co., Ltd.) | |
| Ion-exchanged water | 61.9% by weight |

The above components were mixed and stirred, and filtered by a 1 μm. Thus an aqueous pigment ink according to the invention, Low Color Density Yellow Ink 1, was prepared. The average particle diameter of the pigment in the ink was 118 nm and the surface tension of the ink was 37 mN/m.

Preparation of High Color Density Magenta Ink 1

| | |
|---|---|
| Magenta Pigment Dispersion 1 | 15% by weight |
| Ethylene glycol | 20% by weight |
| Diethylene glycol | 10% by weight |
| Surfactant (Surfinol 465, | 0.1% by weight |
| Nishin Kagaku Kogyo | |
| Co., Ltd.) | |
| Ion-exchanged water | 54.9% by weight |

The above components were mixed and stirred, and filtered by a 1 μm. Thus an aqueous pigment ink according to the invention, High Color Density Magenta Ink 1, was prepared. The average particle diameter of the pigment in the ink was 113 nm and the surface tension of the ink was 35 mN/m.

Preparation of Low Color Density Magenta Ink 1

| | |
|---|---|
| Magenta Pigment Dispersion 1 | 3% by weight |
| Ethylene glycol | 25% by weight |
| Diethylene glycol | 10% by weight |
| Surfactant (Surfinol 465, | 0.1% by weight |
| Nishin Kagaku Kogyo | |
| Co., Ltd.) | |
| Ion-exchanged water | 61.9% by weight |

The above components were mixed and stirred, and filtered by a 1 μm. Thus an aqueous pigment ink according to the invention, Low Color Density Magenta Ink 1, was prepared. The average particle diameter of the pigment in the ink was 110 nm and the surface tension of the ink was 37 mN/m.

Preparation of High Color Density Cyan Ink 1

| | |
|---|---|
| Cyan Pigment Dispersion 1 | 10% by weight |
| Ethylene glycol | 20% by weight |
| Diethylene glycol | 10% by weight |
| Surfactant (Surfinol 465, | 0.1% by weight |
| Nishin Kagaku Kogyo | |
| Co., Ltd.) | |
| Ion-exchanged water | 59.9% by weight |

The above components were mixed and stirred, and filtered by a 1 μm. Thus an aqueous pigment ink according to the invention, High Color Density Cyan Ink 1, was prepared. The average particle diameter of the pigment in the ink was 95 nm and the surface tension of the ink was 36 mN/m.

Preparation of Low Color Density Cyan Ink 1

| | |
|---|---|
| Cyan Pigment Dispersion 1 | 2% by weight |
| Ethylene glycol | 25% by weight |
| Diethylene glycol | 10% by weight |
| Surfactant (Surfinol 465, | 0.2% by weight |
| Nishin Kagaku Kogyo | |
| Co., Ltd.) | |
| Ion-exchanged water | 62.9% by weight |

The above components were mixed and stirred, and filtered by a 1 μm. Thus an aqueous pigment ink according to the invention, Low Color Density Cyan Ink 1, was prepared. The average particle diameter of the pigment in the ink was 92 nm and the surface tension of the ink was 33 mN/m.

Preparation of High Color Density Black Ink 1

| | |
|---|---|
| Black Pigment Dispersion 1 | 10% by weight |
| Ethylene glycol | 20% by weight |
| Diethylene glycol | 10% by weight |
| Surfactant (Surfinol 465, | 0.1% by weight |
| Nishin Kagaku Kogyo | |
| Co., Ltd.) | |
| Ion-exchanged water | 59.9% by weight |

The above components were mixed and stirred, and filtered by a 1 μm. Thus an aqueous pigment ink according to the invention, High Color Density Black Ink 1, was prepared. The average particle diameter of the pigment in the ink was 85 nm and the surface tension of the ink was 35 mN/m.

Preparation of Low Color Density Black Ink 1

| | |
|---|---|
| Black Pigment Dispersion 1 | 2% by weight |
| Ethylene glycol | 25% by weight |
| Diethylene glycol | 10% by weight |
| Surfactant (Surfinol 465, | 0.1% by weight |
| Nishin Kagaku Kogyo | |
| Co., Ltd.) | |
| Ion-exchanged water | 62.9% by weight |

The above components were mixed and stirred, and filtered by a 1 μm. Thus an aqueous pigment ink according to the invention, Low Color Density Black Ink 1, was prepared. The average particle diameter of the pigment in the ink was 89 nm and the surface tension of the ink was 36 mN/m.

Preparation of Dye Ink

Dye inks were prepared according to the followings.

| | |
|---|---|
| Yellow ink | |
| C.I. Acid Yellow 23 | 3% by weight |
| Diethylene glycol | 25% by weight |
| Sodium dioctylsulfosuccinate | 0.01% by weight |
| Water to make | 100% by weight |
| Magenta ink | |
| C.I. Direct Red 227 | 3% by weight |
| Diethylene glycol | 29% by weight |
| Sodium dioctylsulfosuccinate | 0.01% by weight |
| Water to make | 100% by weight |
| Cyan ink | |
| C.I. Direct Blue 199 | 3% by weight |
| Diethylene glycol | 25% by weight |
| Sodium dioctylsulfosuccinate | 0.01% by weight |
| Water to make | 100% by weight |
| Black ink | |
| C.I. Food Black | 4% by weight |
| Diethylene glycol | 25% by weight |
| Sodium dioctylsulfosuccinate | 0.01% by weight |
| Water to make | 100% by weight |

Preparation of Ink-Jet Image

Ink-jet Images 1 through 20 were prepared by combinations of the kinds of the recording medium prepared in Example 1 and the kinds of ink as shown in Table 3.

Each of the images was prepared by the ink-jet printer shown in FIG. 1, in which a head corresponding to four colors was installed when the dye inks were used, and a head corresponding to eight colors was installed when the pigment inks were used. Wedge images of yellow, magenta, cyan and black, a lattice pattern test chart in which bands of yellow, magenta, cyan, blue, green, red and black each having a width of 1 cm were drawn in the vertical and lateral directions and a portrait were printed.

FIG. 1 shows a schematic constitution of an ink-jet recording apparatus having a heating roller usable in the invention.

The four-color corresponding head or the eight-color corresponding head, in each of which inks of yellow, magenta, cyan and black were charged, and the roll-shaped recording medium having a width of 12.7 cm were set in the printer shown in FIG. 1. The image including the wedge images of yellow, magenta, cyan and black was continuously printed. Recording Media 1 through 4 were each supplied in a shape of sheet and the other recording media were each cut every 8.9 cm and supplied for printing. Thus prints corresponding to L size were continuously prepared. After the ink-jet recording, the heat-fixing treatment was provided by the heat-fixing roller at a surface temperature of 105° C. for fusing and making layer the thermoplastic resin in the outermost layer to finish the image formation.

<Evaluation of the Output Image>

As to Images 1 through 20 thus output were evaluated as follows.

[Evaluation of Color Bleed]

The color bleed relating to the ink-absorbing speed was evaluated. The evaluation was preformed by visual observation on the spread of color at the boundaries of the images of each of the yellow, magenta, cyan, blue, green, red and black bands of test chart. The observation results were ranked according to the following norms.

4: Color spreading is almost not observed at the all boundaries of the colors.

3: Color spreading was slightly observed at one or two color boundaries.

2: Color spreading was observed at several color boundaries.

1: Color spreading was considerably observed at several color boundaries.

[Evaluation of Roller Contamination]

Under the foregoing printing conditions, 50 m of the roll-shaped recording medium having a width of 12.7 cm was continuously printed and the situation of adhesion or transfer of foreign substance such as a broken piece of the image on the surface of the roller was visually observed. The results of the observation were ranked according to the following norms.

3. No foreign substance adhered on the surface of the roller was observed.

2: Foreign substances were slightly observed adhered on the roller surface. The contamination level was acceptable for the practical use.

1: Many foreign substances were observed on the roller surface. The contamination level was not acceptable for the practical use.

[Evaluation of Glossiness]

The glossiness in an image clarity C in percent at the image of the solid black portion of the chart was measured at a reflection angle of 600 and an optical comb of 2 mm by an image clarity meter ICM-1DP, manufactured by Suga Test Machine CO., Ltd. The ranking was carried out according to the following norms.

4: Value C in percent was not less than 61.

3: Value C in percent was from 60 to 51.

2: Value C in percent was from 41 to 50.

1: Value C in percent was not more than 40.

The samples ranked into the ranks 4 and 3 were acceptable for the practical use.

[Evaluation of Water-Proof Ability]

Each of the image printed samples were immersed in water at 25° C. for 90 minutes and then naturally dried for 2 days. After that, the occurrence of peeling of the layer was observed. Such the treatment was repeatedly performed. The results of the observation were ranked according to the following norms.

3: No peeling of the layer was occurred by 5 times of the immersion treatment.

2: The peeling of the layer was occurred by 2 to 5 times of the immersion treatment.

1: The peeling of the layer was occurred in the first immersion treatment.

[Evaluation of Light-Fastness]

The part of reflective density of 1.0 of each of the mono-color wedge images of yellow, magenta, cyan and black was irradiated by light of 70,000 lx for 240 hours by a xenon fade meter and the remaining ratio of the reflective density, {(Reflex density after the irradiation by xenon fade mater/Reflex density before the irradiation by xenon fade mater)×100%}, was determined. The evaluation was performed based on the remaining ratio of the magenta image since it was found that the remaining ratio of the reflective density of magenta image was lowest in all the samples. The remaining ratios of the magenta image of the samples were ranked according to the following norms.

5: The remaining ratio of the reflective density was not less than 95%.

4: The remaining ratio of the reflective density was from 85 to less than 95%.

3: The remaining ratio of the reflective density was from 70 to less than 85%.

2: The remaining ratio of the reflective density was from 50 to 70%.

1: The remaining ratio of the reflective density was less than 50%.

[Evaluation of Resistance Against Oxidant Gas]

The resistively against an oxidant gas was evaluated by the following procedure. The images were put on the wall of an office so that the images were not directly irradiated by the sun light and compulsorily exposed to continuously inflowing air. After standing under such condition for 4 months, the variation of the optical density of each of the image was determined.

The evaluation was performed as to the density reduction of the cyan image, since it was found that the reduction of the density of magenta cyan was lowest in all the samples. The results of the determination were ranked according to the following norms.

3: The reduction ratio of the density after the storage for 4 months was less than 5%.

2: The reduction ratio of the density after the storage for 4 months was not less than 5% and less than 10%.

1: The reduction ratio of the density after the storage for 4 months was not less than 10%.

The results of each of the evaluation are shown in Table 3.

TABLE 3

| | | | Evalu- | | | | | | | |
|---|---|---|---|---|---|---|---|---|---|---|
| | | | ation of | | | | | | | |
| Ink- | Record- | | result | Evaluation result of ink-jet image | | | | | | |
| jet | ing | | crack | | Roller | | Water | light | Resistively | |
| image | medium | | occur- | Color | contami- | Glossi- | resis- | fast- | against | |
| No. | No. | Kind of ink | rence | bleed | nation | ness | tively | ness | oxidant gas | Remarks |
| 1 | 1 | Pigment ink | 1 | 1 | 1 | 1 | 1 | 3 | 2 | Comp. |
| 2 | 2 | Pigment ink | 3 | 2 | 2 | 3 | 2 | 4 | 2 | Inv. |
| 3 | 3 | Pigment ink | 3 | 2 | 2 | 2 | 2 | 4 | 2 | Inv. |
| 4 | 4 | Pigment ink | 3 | 2 | 2 | 3 | 2 | 4 | 2 | Inv. |
| 5 | 5 | Pigment ink | 3 | 3 | 3 | 3 | 2 | 4 | 3 | Inv. |
| 6 | 6 | Pigment ink | 3 | 3 | 3 | 3 | 2 | 4 | 3 | Inv. |
| 7 | 7 | Pigment ink | 5 | 4 | 3 | 4 | 3 | 5 | 3 | Inv. |
| 8 | 8 | Pigment ink | 4 | 4 | 3 | 4 | 3 | 5 | 3 | Inv. |
| 9 | 9 | Pigment ink | 5 | 3 | 2 | 3 | 2 | 4 | 2 | Inv. |
| 10 | 10 | Pigment ink | 5 | 3 | 3 | 4 | 3 | 5 | 3 | Inv. |
| 11 | 11 | Pigment ink | 5 | 4 | 3 | 4 | 3 | 5 | 3 | Inv. |
| 12 | 12 | Pigment ink | 4 | 4 | 3 | 4 | 3 | 5 | 3 | Inv. |
| 13 | 13 | Pigment ink | 4 | 3 | 3 | 3 | 3 | 5 | 3 | Inv. |
| 14 | 14 | Pigment ink | 3 | 2 | 2 | 2 | 2 | 3 | 2 | Inv. |
| 15 | 15 | Pigment ink | 4 | 4 | 3 | 4 | 3 | 5 | 3 | Inv. |
| 16 | 16 | Pigment ink | 4 | 4 | 3 | 4 | 3 | 5 | 3 | Inv. |
| 17 | 1 | Dye ink | 1 | 1 | 1 | 1 | — | 1 | 1 | Comp. |
| 18 | 2 | Dye ink | 3 | 2 | 2 | 3 | — | 2 | 2 | Inv. |
| 19 | 8 | Dye ink | 4 | 4 | 3 | 4 | — | 2 | 2 | Inv. |
| 20 | 13 | Dye ink | 4 | 3 | 3 | 3 | — | 2 | 2 | Inv. |

Comp.: Comparative,
Inv.: Inventive

It is understood from Table 1 that the occurrence of crack is few in the samples according to the invention of which ink transfer amount at the contacting time of 40 milliseconds is not less than 10 ml/m².

Moreover, in the system using the pigment inks, samples according to the invention having an ink transfer amount of 10 ml/m² for the contacting time of 40 milliseconds is superior to the comparative sample in the color bleed, glossiness, water resistively, light-fastness and resistively against oxidant gas, and the contamination of the heating roller is smaller compared with the comparative sample. Such the effect can be enhanced by the use of the combination of thermoplastic resin and the inorganic pigment in the outer layer, the use of the hardener for the water-soluble binder, the applying of the aging treatment, making the ink-absorbing capacity to from 22 ml/m² to 60 ml/m², and making the amount of the solid composition of the thermoplastic resin in the outer layer to 2 g/m².

Besides, in the system using the dye inks, the effects the same as in the system using the pigment inks can be confirmed compared with the comparative sample, even though the light-fastness and the resistively against oxidant gas are inferior to those of the pigment ink system.

The ink-jet recording medium and the ink-jet image forming method can be provided by the invention, by which the color bleed and the roller contamination are not occurred, the high glossiness and light fastness are obtained and the occurrence of the cracking defects is inhibited.

What is claimed is:

1. An ink jet recording material comprising a support having thereon an ink absorbing layer, the ink jet recording material having an outer layer containing a thermoplastic resin,
wherein the ink transfer amount of the ink jet recording material is not less than 10 ml/m² for a contacting time of 40 milliseconds according to Bristow method.

2. The ink jet recording material of claim 1, wherein the ink transfer amount for a contacting time of 40 milliseconds of the ink jet recording material is not more than 30 ml/m².

3. The ink jet recording material of claim 1, wherein the outer layer further comprises inorganic pigments.

4. The ink jet recording material of claim 3, wherein the weight ratio of the thermoplastic resin to the inorganic pigments in the outer layer is from 9:1 to 1:9.

5. The ink jet recording material of claim 4, wherein the weight ratio of the thermoplastic resin to the inorganic pigments in the outer layer is from 6:4 to 4:6.

6. The ink jet recording material of claim 1, wherein the ink absorbing layer comprises a water-soluble binder, and in the course of production of the ink jet recording material, a hardener for the water-soluble binder is supplied to the ink jet recording material after forming the ink absorbing layer.

7. The ink jet recording material of claim 1, wherein the ink jet recording material is stored at a temperature within the range of from 35 to 70° C. for not less than 24 hours and not more than 60 days in the course of production of the ink jet recording material after layer-coating and drying.

8. The ink jet recording material of claim 1, wherein the ink jet recording material has an ink transfer amount of not less than 20 ml/m² for a contacting time of 200 milliseconds according to Bristow method.

9. The ink jet recording material of claim 1, wherein the ink jet recording material has a water-absorbing amount of from 22 ml/m² to 60 ml/m².

10. The ink jet recording material of claim 1, wherein the solid component amount of the thermoplastic resin in the outer layer is form 2 g/m² to 20 g/m².

11. An ink jet image forming method comprising:
jetting an ink on to the ink jet recording material described in claim 1, and
fusing the thermoplastic resin in the outer layer or forming a film of the thermoplastic resin in the outer layer.

12. The ink jet image forming method of claim 11, wherein the fusing step or the film-forming step is carried out by at least one of heating, pressing and coating a solvent.

13. The ink jet image forming method of claim 11, wherein the ink is a pigment ink.
